(19) United States
(12) Patent Application Publication
(10) Pub. No.: US 2021/0001640 A1
(43) Pub. Date: Jan. 7, 2021

(54) THERMAL HEAD STRUCTURE CAPABLE OF IMPROVING PRINTING RESOLUTION AND MANUFACTURING METHOD THEREOF

(71) Applicant: Chien Hwa Coating Technology , Inc., Hsinchu (TW)

(72) Inventors: Ming-Jia LI, Hsinchu (TW); Yi-Wei LIN, Hsinchu (TW); Chun-Chen CHEN, Hsinchu (TW)

(21) Appl. No.: 16/889,765

(22) Filed: Jun. 1, 2020

(30) Foreign Application Priority Data
Jul. 1, 2019 (TW) 108123149

(51) Int. Cl. B41J 2/335

(52) U.S. Cl. CPC B41J 2/3357; B41J 2/3351; B41J 2/3353; B41J 2/3354; B41J 2/3359; B41J 2/33535; B41J 2/33515

(57) ABSTRACT

A manufacturing method of a thermal head structure capable of improving printing resolution includes the following steps. A heat storing layer, a first electrode pattern, a heat generating resistor layer, a second electrode pattern and an insulating protective layer are formed to be overlapped on a substrate, and the step of forming the heat generating resistor layer is between the step of forming the first electrode pattern and the step of forming the second electrode pattern chronologically.

### RELATED APPLICATIONS

This application claims priority to Taiwan Application Serial Number 108123149, filed Jul. 1, 2019, which is herein incorporated by reference.

### BACKGROUND

### Field of Disclosure

The disclosure relates to a thermal head structure. More particularly, the disclosure relates to a thermal head structure capable of improving printing resolution and manufacturing method thereof.

### Description of Related Art

A printer adopting heat transfer principles mainly heats a ribbon to vaporize the dye from the ribbon with a thermal print head (TPH) module, and then transfers the dye to a carrier (e.g., paper or plastics).

However, due to limitations in manufacturing techniques, the minimum size of a unit pixel of a printed pattern of a conventional thermal print head module is limited, and thus the resolution of the printed pattern cannot be effectively improved.

### SUMMARY

One aspect of the disclosure is to provide a thermal head structure capable of improving printing resolution and a manufacturing method thereof so as to solve the difficulties mentioned above, that is, to effectively improve the resolution of printed patterns.

In one embodiment of the disclosure, a thermal head structure capable of improving printing resolution which is provided includes a substrate, a heat storing layer, a first electrode layer, a second electrode layer, a heat generating resistor layer and an insulating protective layer. The heat storing layer is provided with a linear ridge portion that is disposed on one surface of the substrate. The first electrode layer is disposed on the linear ridge portion. The second electrode layer is disposed on the linear ridge portion, and a maximum height of the first electrode layer is less than a maximum height of the second electrode layer. The heat generating resistor layer is disposed on the linear ridge portion, and sandwiched between the first electrode layer and the second electrode layer. The heat generating resistor layer, the first electrode layer and the second electrode layer are formed to be an electrical circuit. The insulating protective layer covers the heat generating resistor layer and the second electrode layer.

According to one or more embodiments of the disclosure, in the thermal head structure, an orthographic projection of the heat generating resistor layer to the surface of the substrate is located within a range of the linear ridge portion.

According to one or more embodiments of the disclosure, in the thermal head structure, the first electrode layer is disposed between the linear ridge portion and the heat generating resistor layer, and is directly disposed between the insulating protective layer and the surface of the substrate, the heat generating resistor layer is disposed between the linear ridge portion and the second electrode layer, and the second electrode layer is directly disposed between the insulating protective layer and the surface of the substrate.

According to one or more embodiments of the disclosure, in the thermal head structure, the linear ridge portion is located within a range of an orthographic projection of the heat generating resistor layer to the surface of the substrate.

According to one or more embodiments of the disclosure, in the thermal head structure, the heat generating resistor layer covers the linear ridge portion and the surface of the substrate, the first electrode layer is directly disposed between the heat generating resistor layer and the surface of the substrate, and the heat generating resistor layer is directly disposed between the second electrode layer and the surface of the substrate.

According to one or more embodiments of the disclosure, in the thermal head structure, the first electrode layer further includes a main line portion and a plurality of first traces arranged on the linear ridge portion in parallel, and one end of each of the first traces is connected to the same side of the main line portion.

According to one or more embodiments of the disclosure, in the thermal head structure, the second electrode layer further includes a plurality of second traces arranged on the linear ridge portion in parallel. Each of the second traces is interposed between any two neighboring ones of the first traces.

According to one or more embodiments of the disclosure, in the thermal head structure, each of the first traces projected to the one surface of the substrate has a first orthographic projection, respectively, each of the second traces projected to the one surface of the substrate has a second orthographic projection, respectively, the second orthographic projections and the first orthographic projections are alternately arranged with each other. A gap formed between one of the first orthographic projections and one of the second orthographic projections which are adjacent to each other is 10-15 microns (um).

According to one or more embodiments of the disclosure, in the thermal head structure, the first electrode layer includes a common electrode pattern of the thermal head structure. The second electrode layer includes an individual electrode pattern of the thermal head structure.

In one embodiment of the disclosure, a thermal head structure capable of improving printing resolution which is provided includes a substrate, a linear ridge portion, a first electrode layer, a second electrode layer, a heat generating resistor layer and an insulating protective layer. The linear ridge portion is disposed on one surface of the substrate. The first electrode layer covers the surface of the substrate and the linear ridge portion, and includes a plurality of first traces. The heat generating resistor layer covers the first electrode layer, the linear ridge portion and the surface of the substrate. The second electrode layer covers one surface of the heat generating resistor layer being opposite to the first electrode layer, and is formed to be an electrical circuit with the first electrode layer and the heat generating resistor layer are. The second electrode layer includes a plurality of second traces, each of the first traces projected to the one surface of the substrate has a first orthographic projection, respectively, each of the second traces projected to the one surface of the substrate has a second orthographic projection, respectively, and the second orthographic projections and the first orthographic projections are alternately arranged with each other. The insulating protective layer covers the heat generating resistor layer and the second electrode layer.

According to one or more embodiments of the disclosure, in the thermal head structure, the first electrode layer includes a common electrode pattern of the thermal head structure, and the second electrode layer includes an individual electrode pattern of the thermal head structure.

According to one or more embodiments of the disclosure, in the thermal head structure, the heat generating resistor layer completely covers the linear ridge portion; or the heat generating resistor layer partially covers the linear ridge portion.

In one embodiment of the disclosure, a manufacturing method of a thermal head structure capable of improving printing resolution includes step (a) to step (e) as follows. In step (a), a heat storing layer having a linear ridge portion is formed on one surface of a substrate; In step (b), a first electrode pattern is formed on the linear ridge portion and the surface of a substrate; In step (c), a heat generating resistor layer is formed on the first electrode pattern, the linear ridge portion and the surface of a substrate; In step (d), a second electrode pattern is formed on the heat generating resistor layer and the surface of a substrate; and In step (e), an insulating protective layer is formed on the heat generating resistor layer and the second electrode pattern, and the step (c) is between the step (b) and the step (d) chronologically.

According to one or more embodiments of the disclosure, in the manufacturing method, the step (b) further includes a step of forming a plurality of first traces on the linear ridge portion and the surface of a substrate. The step (d) further includes forming a plurality of second traces on the heat generating resistor layer and the surface of a substrate. Each of the first traces projected to the surface of the substrate has a first orthographic projection, respectively, each of the second traces projected to the surface of the substrate has a second orthographic projection, respectively, and the second orthographic projections and the first orthographic projections are alternately arranged with each other.

According to one or more embodiments of the disclosure, the manufacturing method further includes a step of electrically connecting at least one work unit module to the second electrode pattern after step (e), and the work unit module, the first electrode pattern, the heat generating resistor layer and the second electrode pattern are formed to be an electrical circuit.

According to one or more embodiments of the disclosure, in the manufacturing method, the first electrode pattern includes a common electrode pattern of the thermal head structure, and the second electrode pattern includes an individual electrode pattern of the thermal head structure.

The above description is merely used for illustrating the problems to be resolved, the technical methods for resolving the problems and their efficacies, etc. The specific details of the disclosure will be explained in the embodiments below and related drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1A is a top schematic view of a thermal head structure capable of improving printing resolution according to one embodiment of the disclosure;

FIG. 1B is a transverse cross-sectional view of FIG. 1A;

FIG. 2A is a top schematic view of a thermal head structure capable of improving printing resolution according to one embodiment of the disclosure;

FIG. 2B is a transverse cross-sectional view of FIG. 2A;

FIG. 3 is a flow chart of a manufacturing method of a thermal head structure capable of improving printing resolution according to one embodiment of the disclosure; and

FIG. 4A to FIG. 4P are respectively detailed operation diagrams of the manufacturing method of FIG. 3.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the disclosure without departing from the scope or spirit of the disclosure.

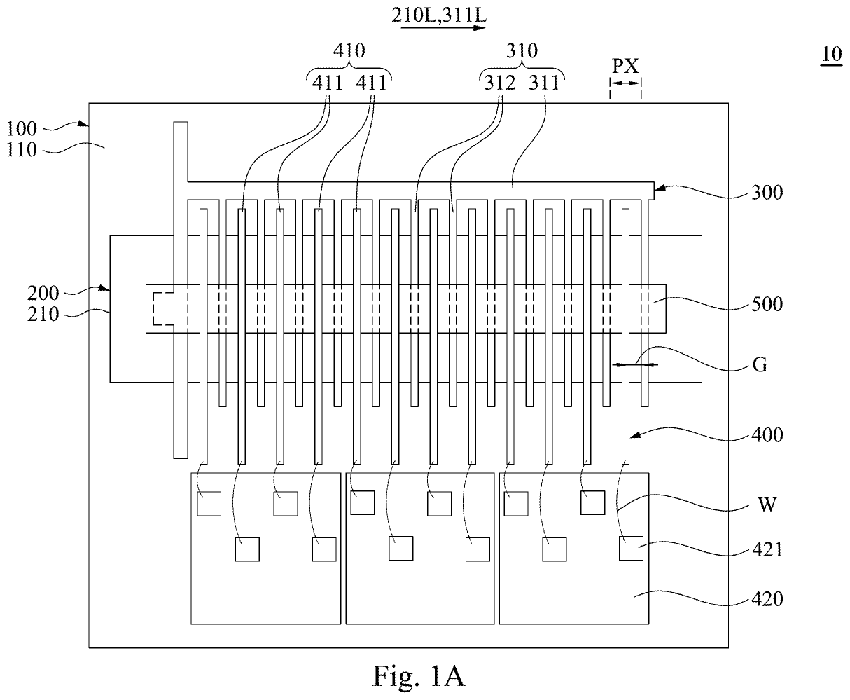

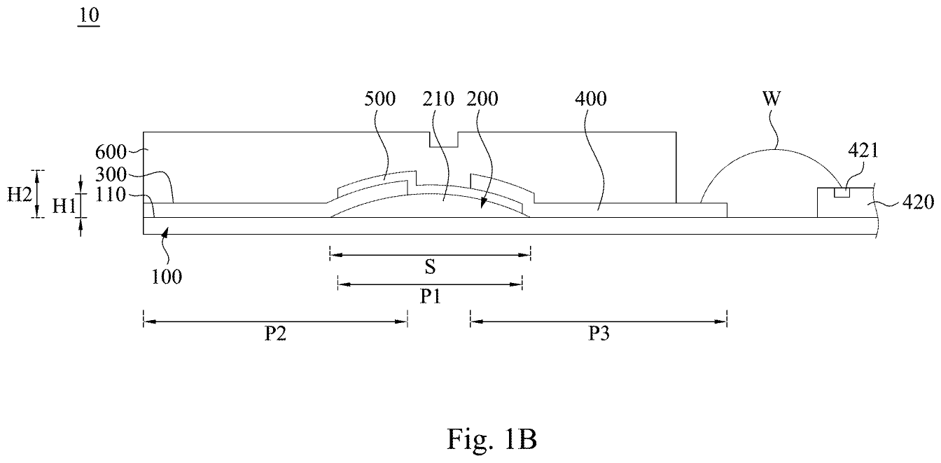

Reference is now made to FIG. 1A to FIG. 1B, in which FIG. 1A is a top schematic view of a thermal head structure 10 capable of improving printing resolution according to one embodiment of the disclosure, and FIG. 1B is a transverse cross-sectional view of FIG. 1A. As shown in FIG. 1A and FIG. 1B, the thermal head structure 10 includes a substrate 100, a heat storing layer 200, a first electrode layer 300, a second electrode layer 400, a heat generating resistor layer 500 and an insulating protective layer 600. The heat storing layer 200 is used to store heat energy so as not to be easily lost. For example, the heat storing layer 200 is provided with a linear ridge portion 210 that is disposed on a top surface 110 of the substrate 100. The linear ridge portion 210 has a long axis direction 210L, that is, the linear ridge portion 210 extends in the long axis direction 210L. The first electrode layer 300 is disposed on the linear ridge portion 210. The first electrode layer 300 includes a first electrode pattern 310. The first electrode pattern 310 covers the top surface 110 of the substrate 100 and the linear ridge portion 210. The second electrode layer 400 is disposed on the linear ridge portion 210, and the second electrode layer 400 includes a second electrode pattern 410. The second electrode pattern 410 covers the top surface 110 of the substrate 100 and the linear ridge portion 210. For example, the first electrode pattern 310 includes a common electrode pattern of the thermal head structure 10, and the second electrode pattern 410 includes an individual electrode pattern of the thermal head structure 10. The heat generating resistor layer 500 is disposed on the linear ridge portion 210, and sandwiched between the first electrode layer 300 and the second electrode layer 400. Specifically, the heat generating resistor layer 500 covers the first electrode layer 300, and the second electrode layer 400 covers the heat generating resistor layer 500. The heat generating resistor layer 500, the first electrode layer 300 and the second electrode layer 400 are formed to be an electrical circuit. The insulating protective layer 600 covers the heat generating resistor layer 500 and the second electrode layer 400. The first electrode layer 300 and the second electrode layer 400 are substantially on different level heights. In other words, a maximum height H1 of the first electrode layer 300 is less than a maximum height H2 of the second electrode layer 400.

In the embodiment, the heat generating resistor layer 500 partially covers the linear ridge portion 210. More specifically, the heat generating resistor layer 500 projected to the top surface 110 of the substrate 100 has a first orthographic projection P1, and the first orthographic projection P1 is located within a range S of the linear ridge portion 210 projected to the top surface 110 of the substrate 100. In other words, the area of the aforementioned range S is greater than the area of the first orthographic projection P1. In addition, one part of the first electrode layer 300 is located between the linear ridge portion 210 and the heat generating resistor layer 500, and another part of the first electrode layer 300 is located between the insulating protective layer 600 and the top surface 110 of the substrate 100, more definitely, the another part of the first electrode layer 300 is directly sandwiched between the insulating protective layer 600 and the top surface 110 of the substrate 100. One part of the heat generating resistor layer 500 is located between the linear ridge portion 210 and the second electrode layer 400, another part of the heat generating resistor layer 500 is located between the insulating protective layer 600 and the linear ridge portion 210, and the other part of the heat generating resistor layer 500 is located between the first electrode layer 300 and the insulating protective layer 600. One part of the second electrode layer 400 is located between the heat generating resistor layer 500 and the insulating protective layer 600, another part of the second electrode layer 400 is located between the insulating protective layer 600 and the top surface 110 of the substrate 100. More specifically, the another part of the second electrode layer 400 is directly sandwiched between the insulating protective layer 600 and the top surface 110 of the substrate 100.

The first electrode layer 300 further includes a main line portion 311 and a plurality of first traces 312. The main line portion 311 is disposed on the top surface 110 of the substrate 100, and is wider than each of the first traces 312. The long axis direction 311L of the main line portion 311 is parallel to the long axis direction 210L of the linear ridge portion 210. The first traces 312 are arranged on the linear ridge portion 210 in parallel. One end of each of the first traces 312 is connected to the same side of the main line portion 311, and each of the first traces 312 crosses over the linear ridge portion 210 to extend to one side of the linear ridge portion 210 opposite to the main line portion 311. The second electrode layer 400 further includes a plurality of second traces 411 arranged on the linear ridge portion 210 in parallel. Each of the second traces 411 is interposed between any two neighboring ones of the first traces 312.

In addition, in the embodiment, the thermal head structure 10 further includes one or more work unit modules 420 (e.g., IC chips). The work unit modules 420 are arranged on the top surface 110 of the substrate 100, and electrically connected to the second electrode layer 400. Each of the work unit modules 420 has a plurality of lead pins 421 in which the second traces 411 of the second electrode layer 400 are electrically connected to the lead pins 421 of the work unit modules 420 so as to receive signals from the work unit modules 420, and the second traces 411 of the second electrode layer 400 are electrically connected to the lead pins 421 of the work unit modules 420 through wire bonding W, however, the disclosure is not limited thereto, and in other embodiments, the work unit modules 420 are electrically connected to the second traces 411 of the second electrode layer 400 through chip of film (COF). Thus, the thermal head structure 10 can electrically connect to the internal circuitry of a printer.

More particularly, each of the first traces 312 projected to the top surface 110 of the substrate 100 has a second orthographic projection P2 (referring to the first traces 312 of FIG. 1A), respectively. Each of the second traces 411 projected to the top surface 110 of the substrate 100 has a third orthographic projection P3 (referring to the second traces 411 of FIG. 1A), respectively. The third orthographic projections P3 (referring to the second traces 411 of FIG. 1A) and the second orthographic projection P2 (referring to the first traces 312 of FIG. 1A) are alternately arranged with each other. In other words, each of the third orthographic projections P3 (referring to the second traces 411 of FIG. 1A) is located between any two adjacent ones of the second orthographic projection P2 (referring to the first traces 312 of FIG. 1A). A minimum gap G is formed between one of the second orthographic projections P2 (referring to the first traces 312 of FIG. 1A) and one of the third orthographic projections P3 (referring to the second traces 411 of FIG. 1A) which are adjacent to each other, and the minimum gap G is 10-15 microns (um). Since the first electrode layer 300 and the second electrode layer 400 are non-coplanar, the arrangement positions of the first electrode layer 300 and the second electrode layer 400 can be closer to each other in deployment, thereby effectively increasing the maximum printed pattern. The resolution, for example, the output resolution of the printed pattern of the thermal print head module can be increased to twice the resolution of conventional output.

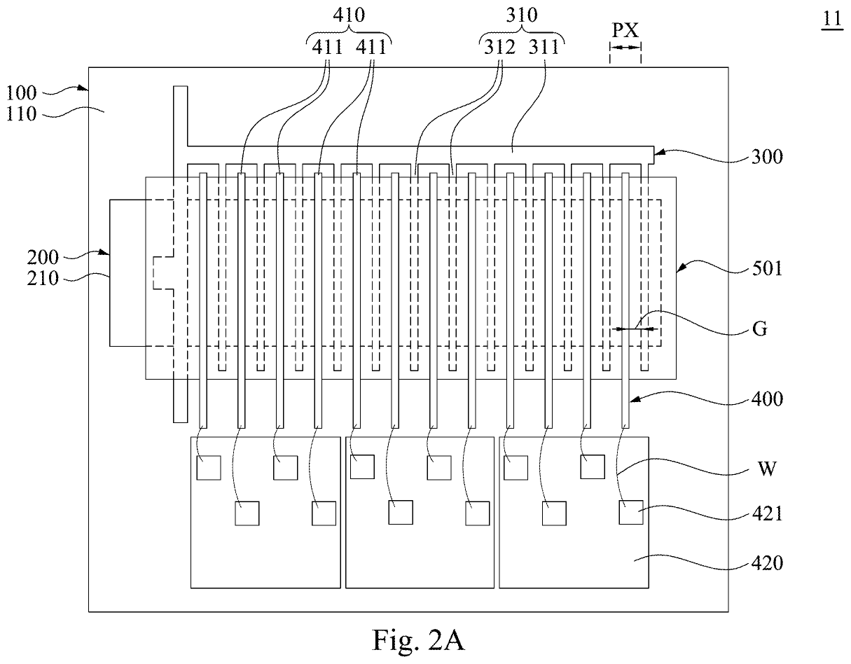

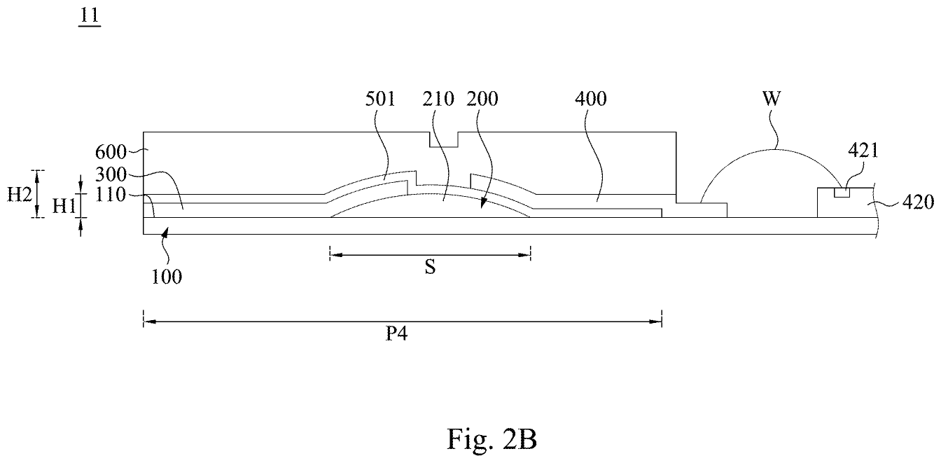

Reference is now made to FIG. 2A to FIG. 2B, in which FIG. 2A is a top schematic view of a thermal head structure 11 capable of improving printing resolution according to one embodiment of the disclosure, and FIG. 2B is a transverse cross-sectional view of FIG. 2A. As shown in FIG. 2A and FIG. 2B, the thermal head structure 11 of the embodiment is substantially the same to the thermal head structure 10 of FIG. 1A. However, at least one difference of the thermal head structure 11 of FIG. 2A from the thermal head structure 10 of FIG. 1A is that, the heat generating resistor layer 500 of FIG. 1A partially covers the linear ridge portion 210 described above merely, rather than completely covers the linear ridge portion 210 described above. In contrast, the heat generating resistor layer 501 of the thermal head structure 11 of the disclosure completely covers the linear ridge portion 210 described above. The heat generating resistor layer 501 is directly located between the top surface 110 of the substrate 100 and the second electrode layer 400, and directly located between the insulating protective layer 600 and the first electrode layer 300, such that the first electrode layer 300 and the second electrode layer 400 can have different levels which are obviously different.

More particularly, the heat generating resistor layer 501 projected to the top surface 110 of the substrate 100 has a fourth orthographic projection P4, and the range S of the linear ridge portion 210 is within the fourth orthographic projection P4. In other words, the area of the aforementioned range S is less than the area of the fourth orthographic projection P4. In addition, one part of the first electrode layer 300 is located between the linear ridge portion 210 and the heat generating resistor layer 501, and another part of the first electrode layer 300 is located between the heat generating resistor layer 501 and the substrate 100, more definitely, the first electrode layer 300 is directly sandwiched between the heat generating resistor layer 501 and the top surface 110 of the substrate 100. One part of the second electrode layer 400 is located between the linear ridge portion 210 and the heat generating resistor layer 501, and another part of the second electrode layer 400 is located between the heat generating resistor layer 501 and the insulating protective layer 600, more definitely, the second electrode layer 400 is directly sandwiched between the heat generating resistor layer 501 and the insulating protective layer 600. Furthermore, the first electrode layer 300 and a part of the heat generating resistor layer 501 are substantially on the same level height. In other words, the first electrode layer 300 and the heat generating resistor layer 501 are in direct contact with the top surface 110 of the substrate 100.

In the above embodiments, the material of the substrate 100 is, for example, glass, ceramic or silicon crystalline. The material of the heat storing layer 200 is, for example, glass glaze. The material of the heat generating resistor layer 500 is, for example, TaN group, TaO group, or the like. The first electrode layer 300 and the second electrode layer 400 are, for example, copper, aluminum or titanium. The material of the insulating protective layer 600 is, for example, silicon oxynitride (SiON) system, silicon nitride (SiN) system, silicon carbide (SiC) system, diamond-Like carbon (DLC) system, etc.

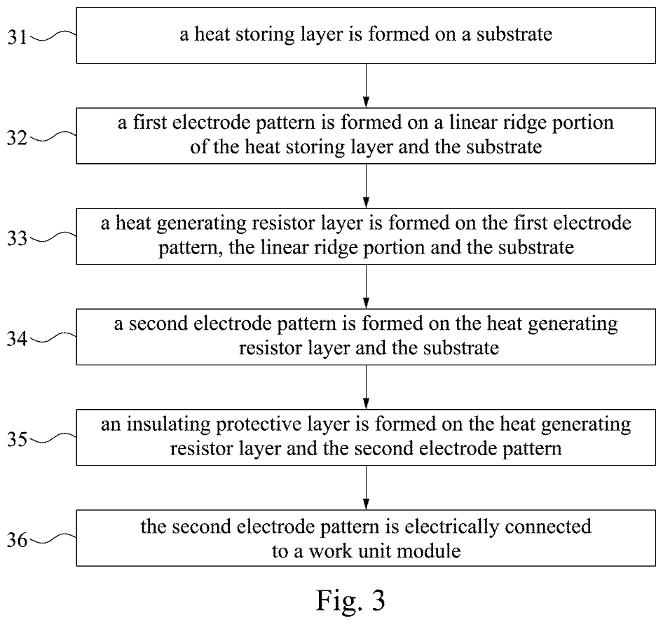

FIG. 3 is a flow chart of a manufacturing method of a thermal head structure 10 capable of improving printing resolution according to one embodiment of the disclosure. As shown FIG. 3, the manufacturing method of the thermal head structure 10 includes steps such as step 31 to step 36 as follows. In step 31, a heat storing layer is formed on a top surface of a substrate in which the heat storing layer has a linear ridge portion. In step 32, a first electrode pattern is formed on a linear ridge portion of the heat storing layer and the top surface of the substrate. In step 33, a heat generating resistor layer is formed on the first electrode pattern, the linear ridge portion and the top surface of the substrate. In step 34, a second electrode pattern is formed on the heat generating resistor layer and the top surface of the substrate. In step 35, an insulating protective layer is formed on the heat generating resistor layer and the second electrode pattern. In step 36, the second electrode pattern is electrically connected to at least one lead pin of a work unit module.

Thus, no matter whether the limitation of the manufacturing technique still exists, since the step 33 is performed between the step 32 and the step 34 chronologically such that the first electrode pattern and the second electrode pattern are substantially on different level heights. In other words, the maximum height of the first electrode pattern is smaller than the maximum height of the second electrode pattern. Therefore, the arrangement positions of the first electrode pattern and the second electrode pattern can be closer to each other in deployment, thereby effectively increasing the maximum printed pattern.

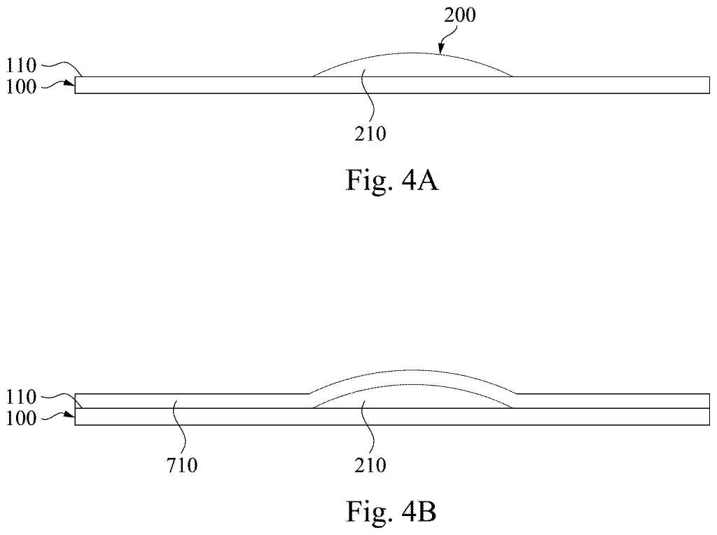

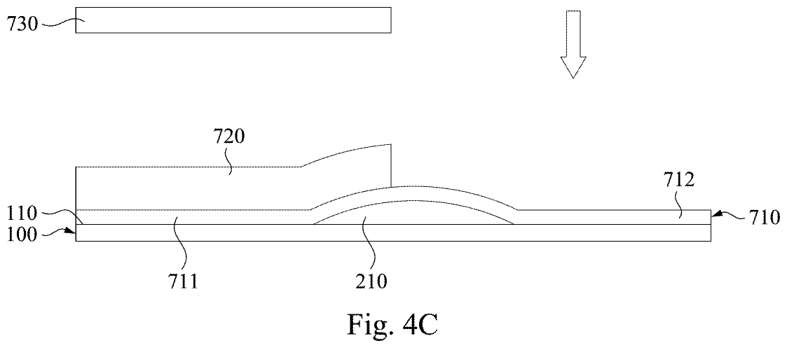

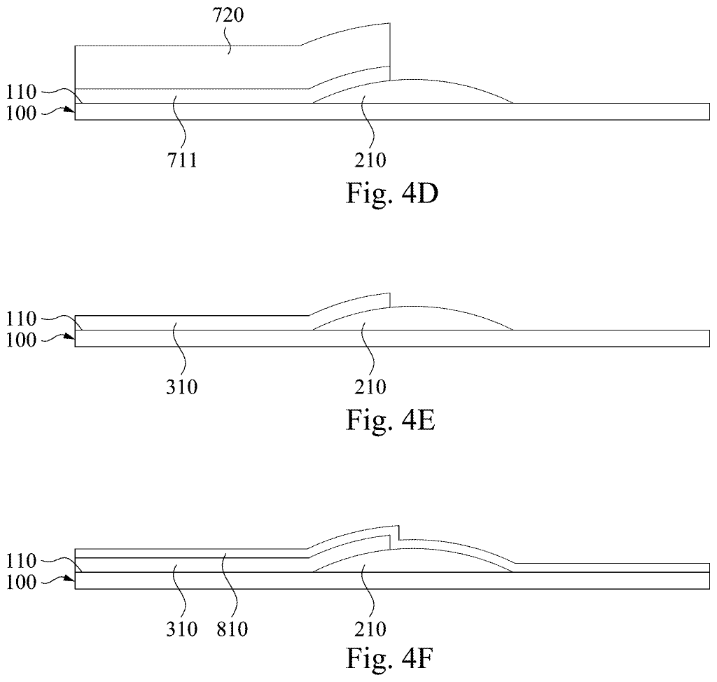

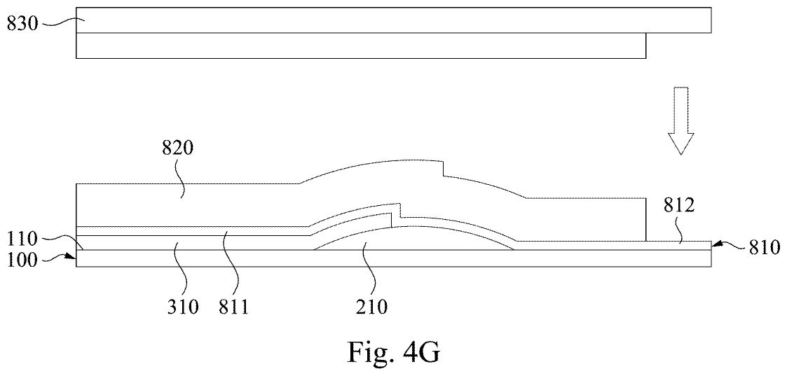

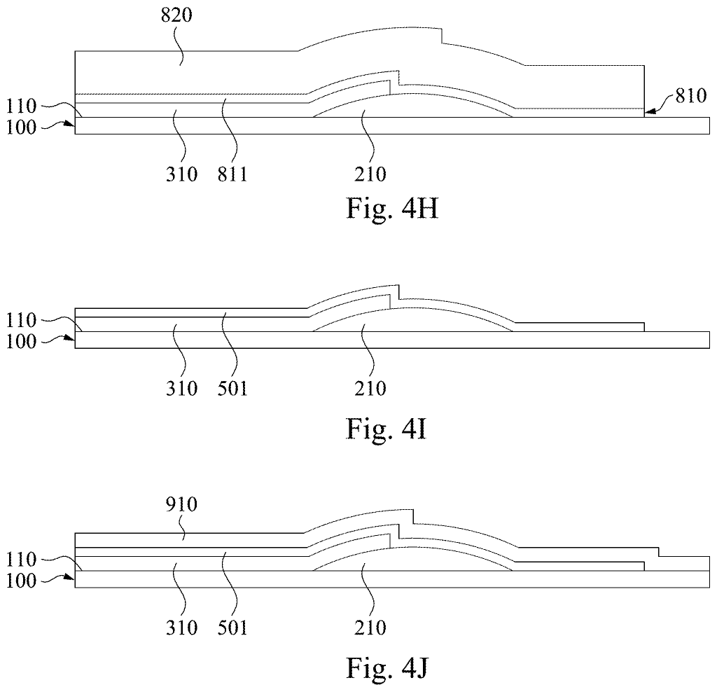

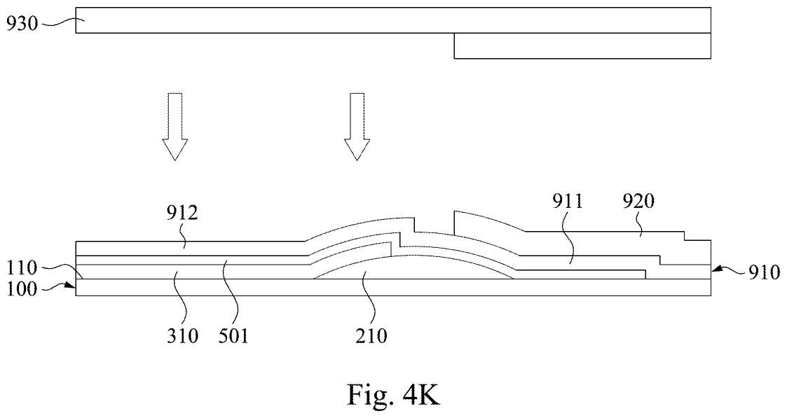

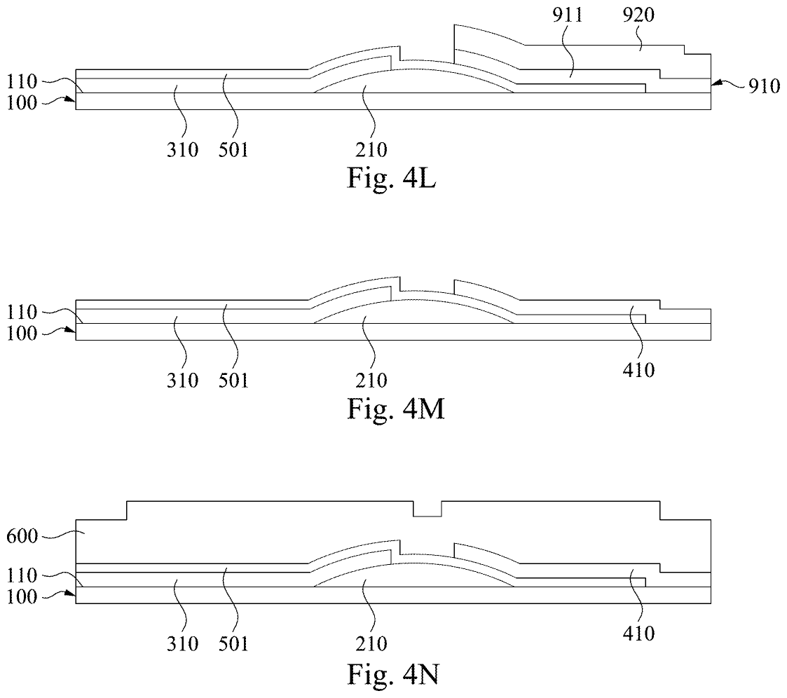

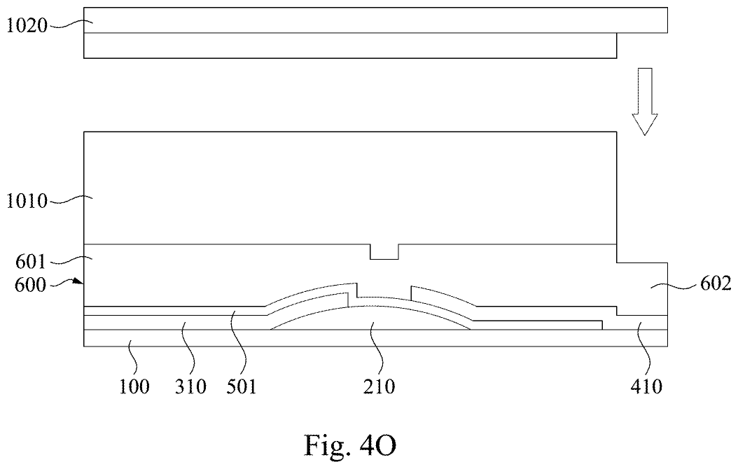

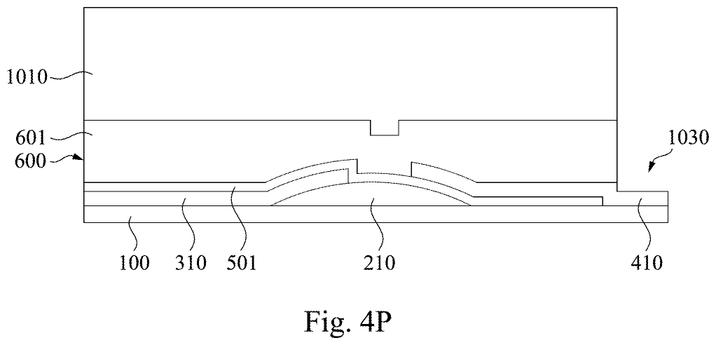

FIG. 4A to FIG. 4P are respectively detailed operation diagrams of the manufacturing method of FIG. 3. As shown in FIG. 4A, in step 31, for example, the linear ridge portion 210 is a stripped pattern formed by printing a glaze paste on the substrate 100 by a screen-printing process and sintering the glaze paste at a high temperature. Furthermore, the substrate 100 is, for example, a ceramic or a silicon crystalline substrate, but the disclosure is not limited to the material of the substrate 100. In addition, the linear ridge portion 210 is arced in cross section on the substrate 100, that is, the apexes of the linear ridge portion 210 is farthest from the top surface 110 of the substrate 100.

As shown in FIG. 4B to FIG. 4E, in step 32, more particularly, a first metal film 710 is formed on the top surface 110 of the substrate 100 and the linear ridge portion 210 according to a plating method (FIG. 4B); next, the first metal film 710 is patterned to form the first electrode pattern 310. (FIG. 4C to FIG. 4E). When the aforementioned first metal film 710 is formed, for example, the first metal film 710 is formed by a chemical vapor deposition (CVD) or physical vapor deposition (PVD), in which the material of the first metal film 710 is, for example, copper, aluminum or titanium or the like. In addition, when the first metal film 710 is patterned, for example, a first photoresist layer 720 is formed on a portion 711 of the first metal film 710, and a first mask 730 is disposed over the first photoresist layer 720 first (FIG. 4C). Next, the first photoresist layer 720 is exposed through the first mask 730 (FIG. 4C). Next, another portion 712 of the first metal film 710 is removed by wet etching method (FIG. 4C to FIG. 4D); next, the first photoresist layer 720 is removed so as to leave the first electrode pattern 310 described above (FIG. 4E).

As shown in FIG. 4F to FIG. 4I, in step 33, a resistive material layer 810 is formed on the first electrode pattern 310, the linear ridge portion 210 and the top surface 110 of the substrate 100 (FIG. 4F) according to a coating method. Next, the resistive material layer 810 is patterned to form the above-mentioned the heat generating resistor layer 501 (FIG. 4G to FIG. 4I). When the aforementioned resistive material layer 810 is formed, for example, by a chemical vapor deposition (CVD) or physical vapor deposition (PVD), the aforementioned heat generating resistor layer 501 is formed on the first electrode pattern 310, the linear ridge portion 210 and the top surface 110 of the substrate 100. The material of the heat generating resistor layer 501 is, for example, TaN, TaO or the like. In addition, when the aforementioned resistive material layer 810 is patterned, for example, a second photoresist layer 820 is formed on a portion 811 of the resistive material layer 810 first, and a second mask 830 is disposed over the second photoresist layer 820 (FIG. 4G). Next, the second photoresist layer 820 is exposed through the second mask 830 (FIG. 4G). Next, another portion 812 of the resistive material layer 810 is removed by dry etching method (FIG. 4G to FIG. 4H); next, the second photoresist layer 820 is removed so as to leave the heat generating resistor layer 501 described above (FIG. 4I).

As shown in FIG. 4J to FIG. 4M, in step 34, more particularly, a second metal film 910 is formed on the heat generating resistor layer 501 and the top surface 110 of the substrate 100 according to a plating method (FIG. 4J); next, the second metal film 910 is patterned to form the second electrode pattern 410. (FIG. 4K to FIG. 4M). When the aforementioned second metal film 910 is formed, for example, the second metal film 910 is formed by a chemical vapor deposition (CVD) or physical vapor deposition (PVD), in which the material of the second metal film 910 is, for example, copper, aluminum or titanium or the like. In addition, when the second metal film 910 is patterned, for example, a third photoresist layer 920 is formed on a portion 911 of the second metal film 910, and a third mask 930 is disposed over the third photoresist layer 920 first (FIG. 4K). Next, the third photoresist layer 920 is exposed through the third mask 930 (FIG. 4K). Next, another portion 912 of the second metal film 910 is removed by wet etching method (FIG. 4K to FIG. 4L); next, the third photoresist layer 920 is removed so as to leave the second electrode pattern 410 described above (FIG. 4M). At this moment, as shown in FIG. 4M, the first electrode pattern 310 and the second electrode pattern 410 are respectively disposed at two opposite sides of the linear ridge portion 210, and the first electrode pattern 310 is disposed at one side of the heat generating resistor layer 501 facing towards the substrate 100, and the second electrode pattern 410 is disposed at one side of the heat generating resistor layer 501 facing away from the substrate 100.

As shown in FIG. 4N to FIG. 4P, in step 35, an insulating protective layer 600 is formed on the heat generating resistor layer 501 and the second electrode pattern 410; next, the insulating protective layer 600 is patterned so as to outwardly expose a part of the second electrode pattern 410 (FIG. 4O to FIG. 4P). When the aforementioned insulating protective layer 600 is formed, for example, by a chemical vapor deposition (CVD), the aforementioned insulating protective layer 600 is formed on the heat generating resistor layer 501 and the second electrode pattern 410. Furthermore, when aforementioned insulating protective layer 600 is patterned, for example, a fourth photoresist layer 1010 is formed on a portion 601 of the insulating protective layer 600 first, and a fourth mask 1020 is disposed over the fourth photoresist layer 1010 (FIG. 4O). Next, the fourth photoresist layer 1010 is exposed through the fourth mask 1020 (FIG. 4O). Next, another portion 602 of the insulating protective layer 600 is removed by dry etching method (FIG. 4K to FIG. 4L) so as to form an opening 1030 exposing the second electrode pattern 410 outwards from the insulating protective layer 600; next, the fourth photoresist layer 1010 is removed (FIG. 4O to FIG. 4P).

Referring to FIG. 2B, in step 36, more specifically, the work unit modules 420 are disposed on the top surface 110 of the substrate 100, and the lead pins 421 of the work unit modules 420 are electrically connected to the second electrode pattern 410 through the opening 1030 by wire bonding W.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A thermal head structure capable of improving printing resolution, comprising:
a substrate;
a heat storing layer having a linear ridge portion disposed on one surface of the substrate;
a first electrode layer disposed on the linear ridge portion;
a second electrode layer disposed on the linear ridge portion, wherein a maximum height of the first electrode layer is less than a maximum height of the second electrode layer;
a heat generating resistor layer disposed on the linear ridge portion, and sandwiched between the first electrode layer and the second electrode layer, wherein the heat generating resistor layer, the first electrode layer and the second electrode layer are formed to be an electrical circuit; and
an insulating protective layer covering the heat generating resistor layer and the second electrode layer.

2. The thermal head structure capable of improving printing resolution of claim 1, wherein an orthographic projection of the heat generating resistor layer to the one surface of the substrate is located within a range of the linear ridge portion.

3. The thermal head structure capable of improving printing resolution of claim 2, wherein the first electrode layer is disposed between the linear ridge portion and the heat generating resistor layer, and is directly disposed between the insulating protective layer and the one surface of the substrate, the heat generating resistor layer is disposed between the linear ridge portion and the second electrode layer, and the second electrode layer is directly disposed between the insulating protective layer and the one surface of the substrate.

4. The thermal head structure capable of improving printing resolution of claim 1, wherein the linear ridge portion is located within a range of an orthographic projection of the heat generating resistor layer to the one surface of the substrate.

5. The thermal head structure capable of improving printing resolution of claim 4, wherein the heat generating resistor layer covers the linear ridge portion and the one surface of the substrate, the first electrode layer is directly disposed between the heat generating resistor layer and the one surface of the substrate, and the heat generating resistor layer is directly disposed between the second electrode layer and the one surface of the substrate.

6. The thermal head structure capable of improving printing resolution of claim 1, wherein the first electrode layer further comprises:
a main line portion; and
a plurality of first traces arranged on the linear ridge portion in parallel, and one end of each of the first traces is connected to the same side of the main line portion.

7. The thermal head structure capable of improving printing resolution of claim 6, wherein the second electrode layer further comprises:
a plurality of second traces arranged on the linear ridge portion in parallel, and each of the second traces is interposed between any two neighboring ones of the first traces.

8. The thermal head structure capable of improving printing resolution of claim 7, wherein each of the first traces projected to the one surface of the substrate has a first orthographic projection, respectively, each of the second traces projected to the one surface of the substrate has a second orthographic projection, respectively, the second orthographic projections and the first orthographic projections are alternately arranged with each other,
wherein a gap formed between one of the first orthographic projections and one of the second orthographic projections which are adjacent to each other is 10-15 microns (um).

9. The thermal head structure capable of improving printing resolution of claim 7, wherein the first electrode layer comprises a common electrode pattern of the thermal head structure, and the second electrode layer comprises an individual electrode pattern of the thermal head structure.

10. A thermal head structure capable of improving printing resolution, comprising:
a substrate;
a linear ridge portion disposed on one surface of the substrate;
a first electrode layer covering the one surface of the substrate and the linear ridge portion, and comprising a plurality of first traces;
a heat generating resistor layer covering the first electrode layer, the linear ridge portion and the one surface of the substrate;
a second electrode layer covering one surface of the heat generating resistor layer being opposite to the first electrode layer, and formed to be an electrical circuit with the first electrode layer and the heat generating resistor layer are, wherein the second electrode layer comprises a plurality of second traces, each of the first traces projected to the one surface of the substrate has a first orthographic projection, respectively, each of the second traces projected to the one surface of the substrate has a second orthographic projection, respectively, and the second orthographic projections and the first orthographic projections are alternately arranged with each other; and
an insulating protective layer covering the heat generating resistor layer and the second electrode layer.

11. The thermal head structure capable of improving printing resolution of claim 10, wherein the first electrode layer comprises a common electrode pattern of the thermal head structure, and the second electrode layer comprises an individual electrode pattern of the thermal head structure.

12. The thermal head structure capable of improving printing resolution of claim 10, wherein the heat generating resistor layer completely covers the linear ridge portion; or the heat generating resistor layer partially covers the linear ridge portion.

13. A manufacturing method of a thermal head structure capable of improving printing resolution, comprising:
(a) forming a heat storing layer having a linear ridge portion on one surface of a substrate;
(b) forming a first electrode pattern on the linear ridge portion and the one surface of a substrate;
(c) forming a heat generating resistor layer on the first electrode pattern, the linear ridge portion and the one surface of a substrate;
(d) forming a second electrode pattern on the heat generating resistor layer and the one surface of a substrate; and
(e) forming an insulating protective layer on the heat generating resistor layer and the second electrode pattern, wherein the step (c) is between the step (b) and the step (d) chronologically.

14. The manufacturing method of the thermal head structure capable of improving printing resolution of claim 13, wherein the step (b) further comprises: forming a plurality of first traces on the linear ridge portion and the one surface of a substrate; and
the step (d) further comprises: forming a plurality of second traces on the heat generating resistor layer and the one surface of a substrate,
wherein each of the first traces projected to the one surface of the substrate has a first orthographic projection, respectively, each of the second traces projected to the one surface of the substrate has a second orthographic projection, respectively, and the second orthographic projections and the first orthographic projections are alternately arranged with each other.

15. The manufacturing method of the thermal head structure capable of improving printing resolution of claim 13, further comprising:
electrically connecting at least one work unit module to the second electrode pattern after step (e), wherein the at least one work unit module, the first electrode pattern, the heat generating resistor layer and the second electrode pattern are formed to be an electrical circuit.

16. The manufacturing method of the thermal head structure capable of improving printing resolution of claim 13, wherein the first electrode pattern comprises a common electrode pattern of the thermal head structure, and the second electrode pattern comprises an individual electrode pattern of the thermal head structure.
